(19) United States
(12) Patent Application Publication
(10) Pub. No.: US 2014/0092100 A1
(43) Pub. Date: Apr. 3, 2014

(54) Dial Menu

(71) Applicant: AFOLIO INC., San Francisco, CA (US)

(72) Inventor: She-Rae Chen, San Francisco, CA (US)

(73) Assignee: AFOLIO INC., San Francisco, CA (US)

(21) Appl. No.: 13/633,838

(22) Filed: Oct. 2, 2012

(51) Int. Cl. G06T 13/00; G06F 3/041

(52) U.S. Cl. 345/473; 345/173

(57) ABSTRACT

A method for providing a user interface includes displaying a first screen with a dial menu. The dial menu is shown as an arch divided into sections that hold first menu options. In response to detecting a gesture to rotate the dial menu, the method includes displaying an animated rotation of the dial menu where at least one first menu option is rotated off the first screen and, when the number of the first menu options exceeds the number of the sections, at least another first menu option is rotated into the first screen. In response to detecting a selection of a first menu option, the method includes displaying a second screen having the dial menu now with the sections holding second menu options different from the first menu options.

### BACKGROUND

Mobile computing devices have relatively small displays so it is important to design graphical user interfaces that efficiently use limited real estate.

### BRIEF DESCRIPTION OF THE DRAWINGS

In the drawings:

FIG. 1A illustrates a screen with a dial menu in one or more examples of the present disclosure;

FIG. 1B illustrates a screen with another dial menu in one or more examples of the present disclosure;

FIG. 2 illustrates the dial menu with its menu options rotated in a first direction off of the screen in one or more examples of the present disclosure;

FIG. 3 illustrates the dial menu with the last menu option rotated in a second direction past a set point in one or more examples of the present disclosure;

FIG. 4 shows a scenario where the dial menu does not change after an application goes from one screen to another in one or more examples of the present disclosure;

FIG. 5 shows a scenario where the dial menu changes after the application goes from one screen to another in one or more examples of the present disclosure;

FIG. 6 shows a scenario where the dial menu does not change after the application changes content on a screen in one or more examples of the present disclosure;

FIG. 7 shows a scenario where the dial menu changes when the application remains on the same screen with the same content in one or more examples of the present disclosure;

FIG. 8 is a block diagram of a computing device for implementing the dial menu in one example of the present disclosure; and

FIG. 9 is a flowchart of a method to implement the dial menu in one example of the present disclosure.

Use of the same reference numbers in different figures indicates similar or identical elements.

### DETAILED DESCRIPTION OF THE INVENTION

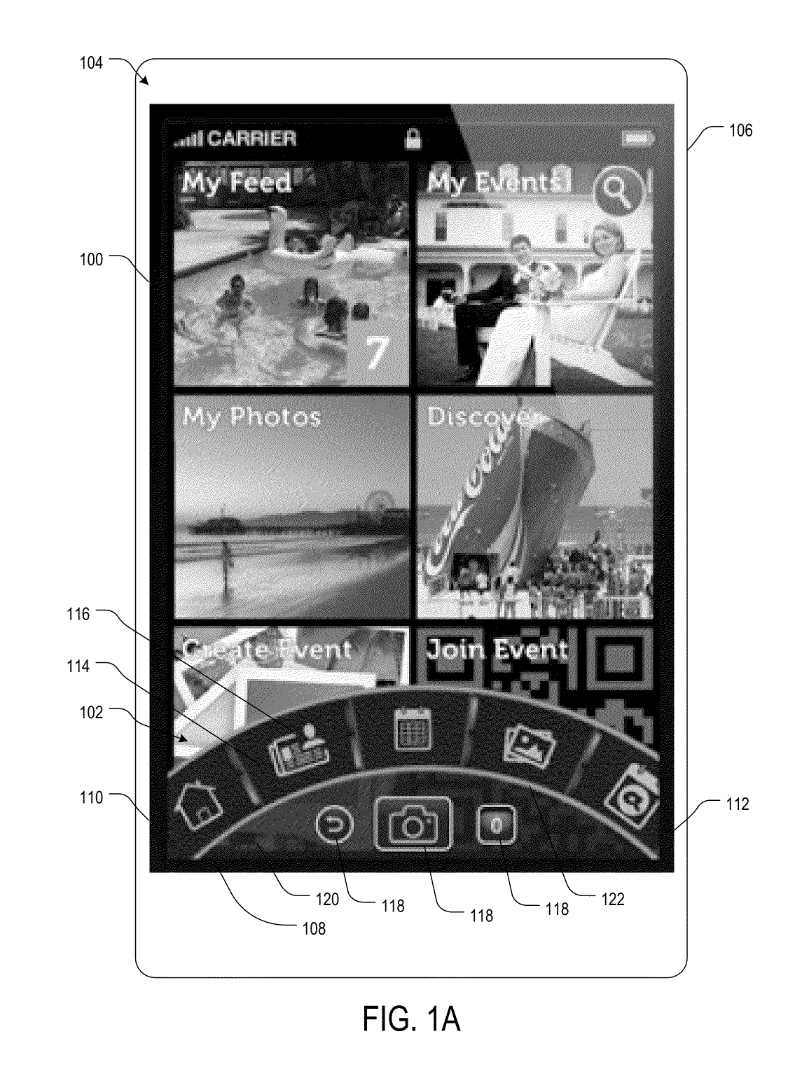

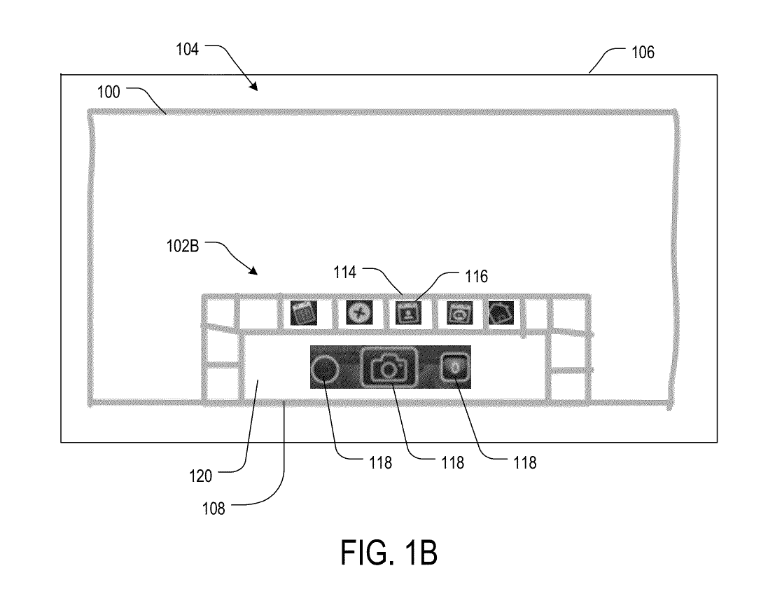

FIG. 1A illustrates a screen 100 with a dial menu 102 in one or more examples of the present disclosure. Dial menu 102 is used to interact with an application 104 on a computing device 106. Computing device 106 may be a mobile phone or a tablet computer. Computing device 106 includes a touch screen and recognizes touch gestures. Alternatively computing device 106 includes a touchpad or another input device to receive touch gestures. Application 104 may be software for creating, collecting, and sharing event photos. Instead of the examples provided above, dial menu 102 may be used with other software applications and hardware. For example, application 104 may be a video application or travel application.

Dial menu 102 has a list of options or commands arranged along a non-linear path. In one example, dial menu 102 is represented as an arch on screen 100 to give the appearance that the dial menu is a control knob with only a portion visible on the screen and the remainder lying outside of the screen. Dial menu 102 is segmental (less than a semicircle), semicircular, or greater than a semicircle but less than a circle. Alternatively dial menu 102 is less than a semi-ellipse, semi-elliptical, or greater than a semi-ellipse but less than an ellipse.

Dial menu 102 is located close to an edge 108 and may span edge 108 or adjacent edges 110 and 112 on screen 100. For example, dial menu 102 may be located in the bottom third or fourth of screen 100 to minimize its footprint. Alternatively dial menu 102 may be located close a corner of screen 100 abutting two adjacent edges. For example, dial menu 102 may be located in the lower right quadrant of screen 100.

Dial menu 102 is divided into sections 114 to hold all or a subset of menu options 116 (only one is labeled). Sections 114 may have a minimum width so that each menu option 116 is easily discerned. When the number of menu options 116 is small, the width may be expanded to evenly distribute the menu options along dial menu 102. The number of menu options 116 may exceed the number of sections 114 (only one is labeled) so less than all of the menu options are visible at a given time on screen 100. For example, dial menu 102 may have a total of eight menu options 116 with six visible on screen 100 and two additional options to be displayed when the dial menu is rotated. Additional menu options 118 are located in an area 120 between a convex side 122 of dial menu 102 and edge 108 of screen 100.

FIG. 1B shows a dial menu 102B having a list of menu options 116 arranged along a different non-linear path in one example of the present disclosure. The non-linear path is U-shaped.

Touch gestures are used to control dial menu 102. A user taps, presses, or uses another similar gesture to select a menu option 116 from dial menu 102. A user flicks, swipes, drags, or uses another similar gesture to rotate dial menu 102 clockwise or counterclockwise. In response to detecting such a gesture to rotate dial menu 102, computing device 106 displays an animated rotation of the dial menu where at least one menu option 116 is rotated off screen 100. When a user flicks or swipes dial menu 102, the dial menu will be rotated by an amount proportional to the magnitude of the motion and then stop. Furthermore, when less than all of the menu options 116 are visible at a given time on screen 100, at least another menu option 116 is rotated into the screen.

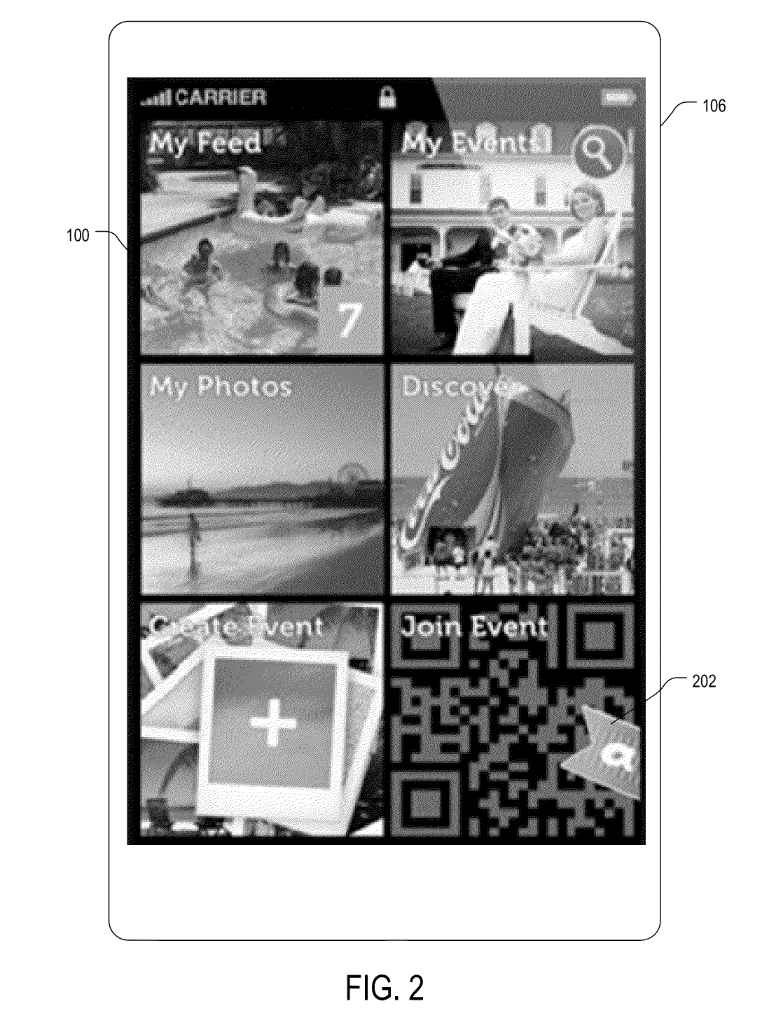

The user may retract dial menu 102 by rotating the dial menu in a first direction (e.g., clockwise) until all the menu options 116 are rotated off screen 100. In response, computing device 106 displays only a tab 202 representing the head of the dial menu as shown in FIG. 2. This effectively removes dial menu 102 (FIG. 1A) from screen 100 so the user has an unobstructed view of one or more contents on the screen. When the user flicks, swipes, drags, or uses another similar gesture to pull tab 202 in a second direction (e.g., counterclockwise), computing device 106 displays another animated rotation of dial menu 102 to bring back the dial menu with one or more menu options 116 on screen 100 as shown in FIG. 1A. The user may also simply tap on tab 202 to bring back dial menu 102. Note that dial menu 102 may start in a retracted state as shown in FIG. 2.

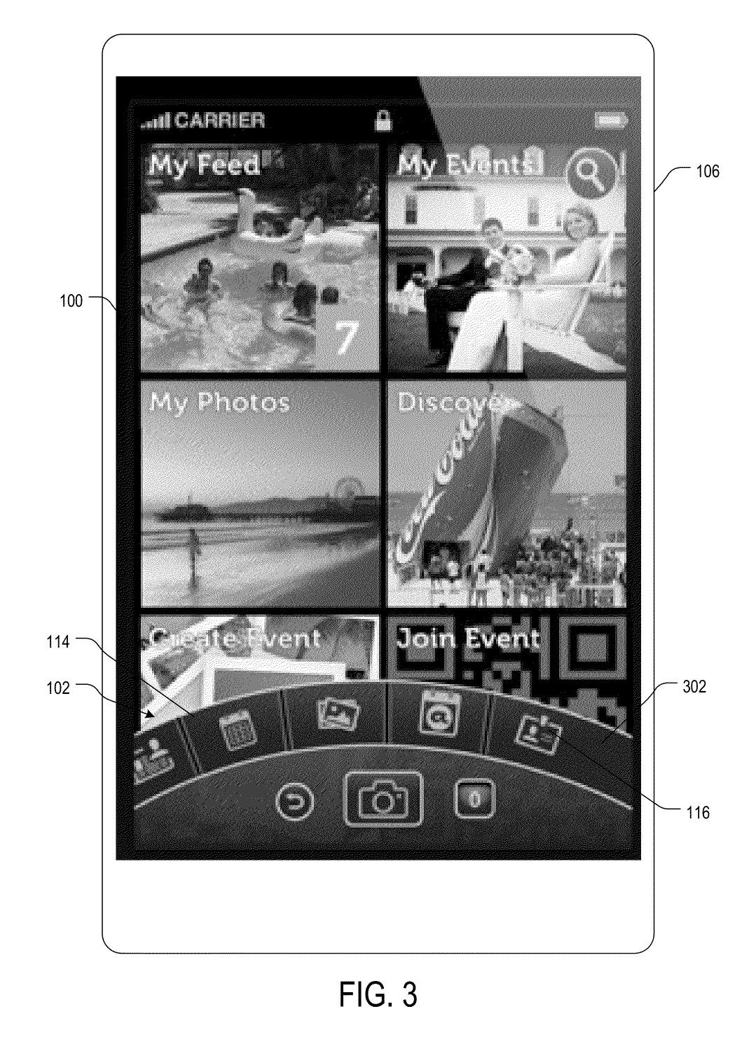

The user may rotate dial menu 102 in the second direction (e.g., counterclockwise) until the very last of the menu options 116 is rotated past a set point on screen 100 as shown in FIG. 3. Note that the last menu option 116 is followed by a blacked out area 302. When the user releases dial menu 102, computing device 106 displays an animated spring back action of the dial menu where additional first menu options 116 are brought back into view on screen 100 as shown in FIG. 1A.

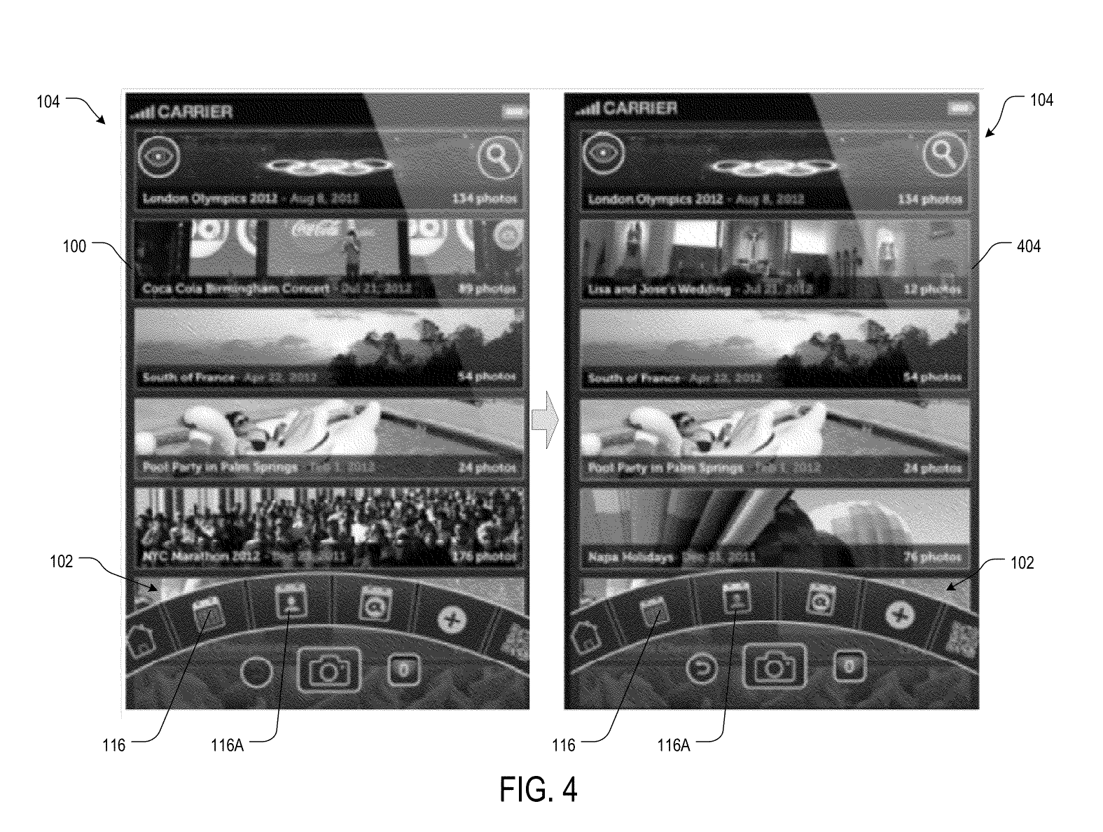

FIG. 4 shows a scenario where dial menu 102 does not change after application 104 goes from screen 100 to a screen 404 in one or more examples of the present disclosure. In one example, screen 100 is an “All Events” screen where the user sees all the accessible events for collecting and sharing event photos, and screen 404 is a “My Events” screen where the user sees only the events she has created. Computing device 106 (FIG. 1A) detects the user selecting a “My Events” menu option 116A on screen 100 to switch from “All Events” to “My Events” screen. In response, computing device 106 displays screen 404. As the context of screen 404 remains the same as screen 100 since they both display event screens, screen 404 includes the same dial menu 102 with the same menu options 116 as screen 100.

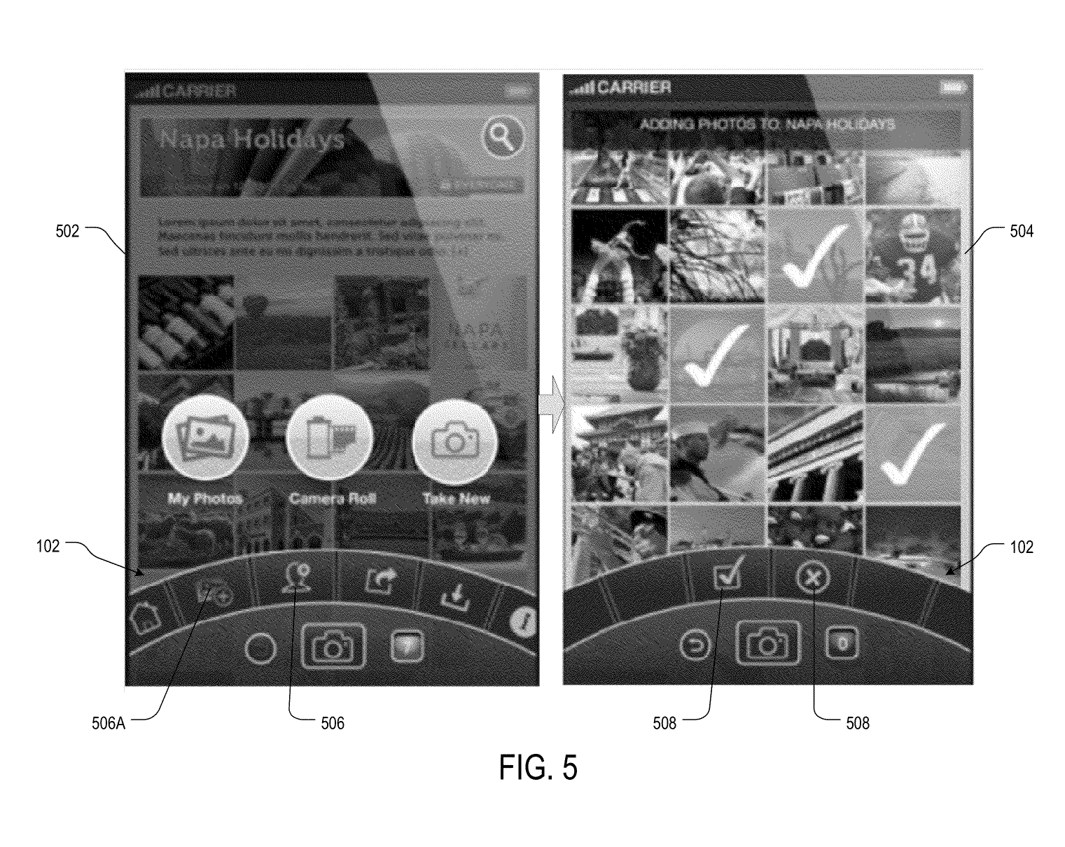

FIG. 5 shows a scenario where dial menu 102 changes after application 104 goes from a screen 502 to a screen 504 in one or more examples of the present disclosure. In one example, screen 502 is an “Event” screen showing the event and options available when a user selects an “Add Photos” option 506A on dial menu 102, and screen 504 is an “Adding Photos from My Photos” screen where the user adds photos to the event from her “My Photos” library. Computing device 106 detects the user selecting an add photo menu option 506A in dial menu 102 on screen 502. In response, computing device 106 displays screen 504. As the context of screen 504 is different from screen 502, computing device 106 updates dial menu 102 for selecting new menu options 508 that are relevant to screen 504 and different from menu options 506 for screen 502. Specifically, computing device 106 replaces the visible menu options 506 with at least a subset of menu options 508. As described before, rotating dial menu 102 may move at least one menu option 508 off screen 504 and introduce another menu option 508 onto the screen when they cannot all fit on the dial menu.

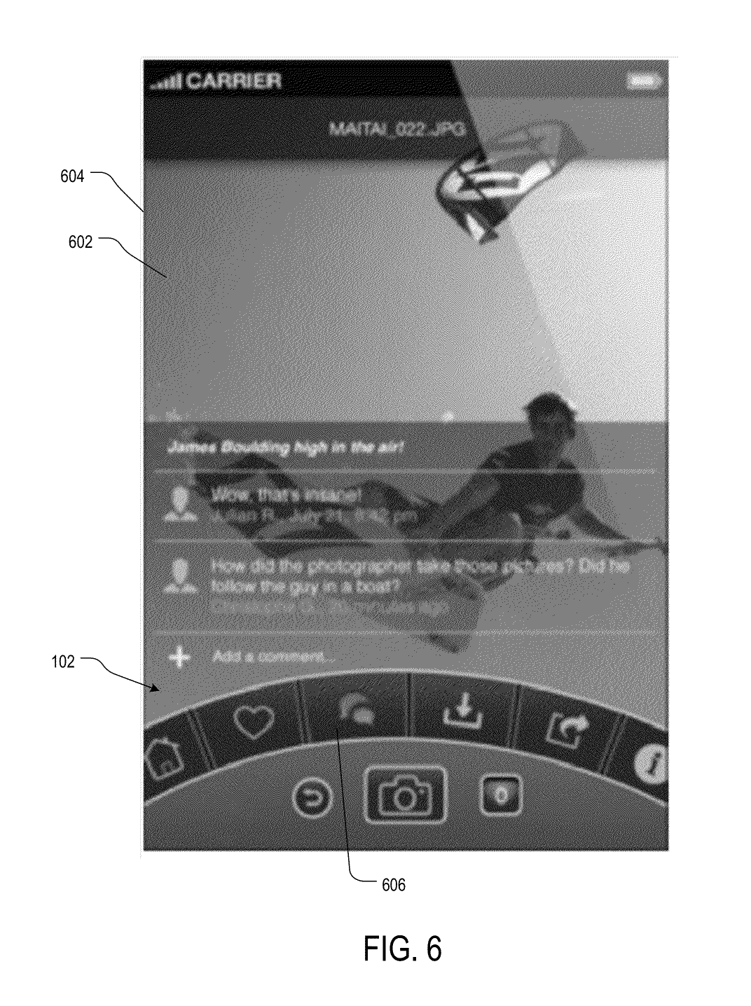

FIG. 6 shows a scenario where dial menu 102 does not change after application 104 changes a content 602 on a screen 604 in one or more examples of the present disclosure. In one example, screen 604 is a “Full Screen Photo” screen having a content 602 of a single photo. Computing device 106 detects the user flicking, swiping, dragging, or using another similar gesture to advance to a new photo on screen 604. In response, computing device 106 displays a new photo on screen 604. As the context of screen 604 remains the same since the content type is unchanged, the screen includes the same dial menu 102 with the same menu options 606 (only one is labeled).

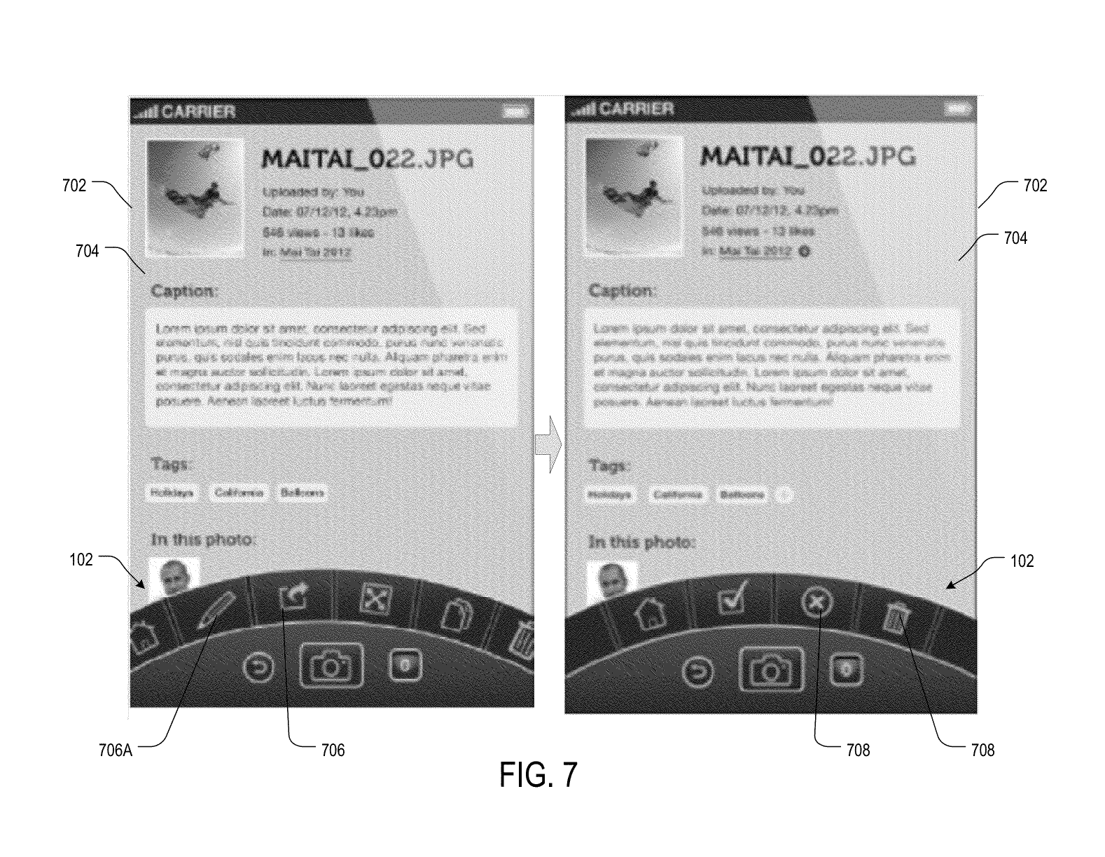

FIG. 7 shows a scenario where dial menu 102 changes when application 104 remains on the same screen 702 with the same content 704 in one or more examples of the present disclosure. In one example, screen 702 is a “Photo Information” screen for a photo. Computing device 106 detects the user selecting an “Edit” menu option 706A from dial menu 102 on screen 702 in a first state. In response, computing device 106 updates dial menu 102 for selecting new menu options 708 that are relevant editing and different from menu options 706. Specifically, computing device 106 replaces the visible menu options 706 with at least a subset of menu options 708. As described before, rotating dial menu 102 may move at least one menu option 708 off screen 702 and introduce another menu option 708 onto the screen when they cannot all fit on the dial menu.

Some of the menu options in dial menu 102 described above may be used to apply a local action to the content on a screen. For example, the user may select a menu option to edit a photo by applying effects or cropping the photo. Such a selection would cause computing device 106 to locally process the photo.

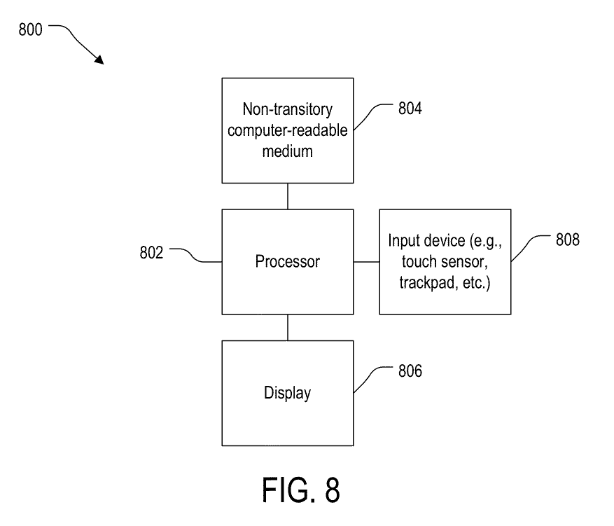

FIG. 8 is a block diagram of a computing device 800 for implementing dial menu 102 (FIGS. 1 to 7) in one or more examples of the present disclosure. Computing device 800 includes a processor 802 that executes instructions 804 stored in a non-transitory computer-readable medium, such as a hard disk drive or a solid state drive. Computer executable instructions 804 implement the user interface including dial menu 102. Processor 802 provides the dial menu on a display 806. Processor 802 captures user input through an input device 808 and decodes the user input as a gesture. In one example, input device 808 is a touch sensor that forms part of a touchscreen or a touchpad.

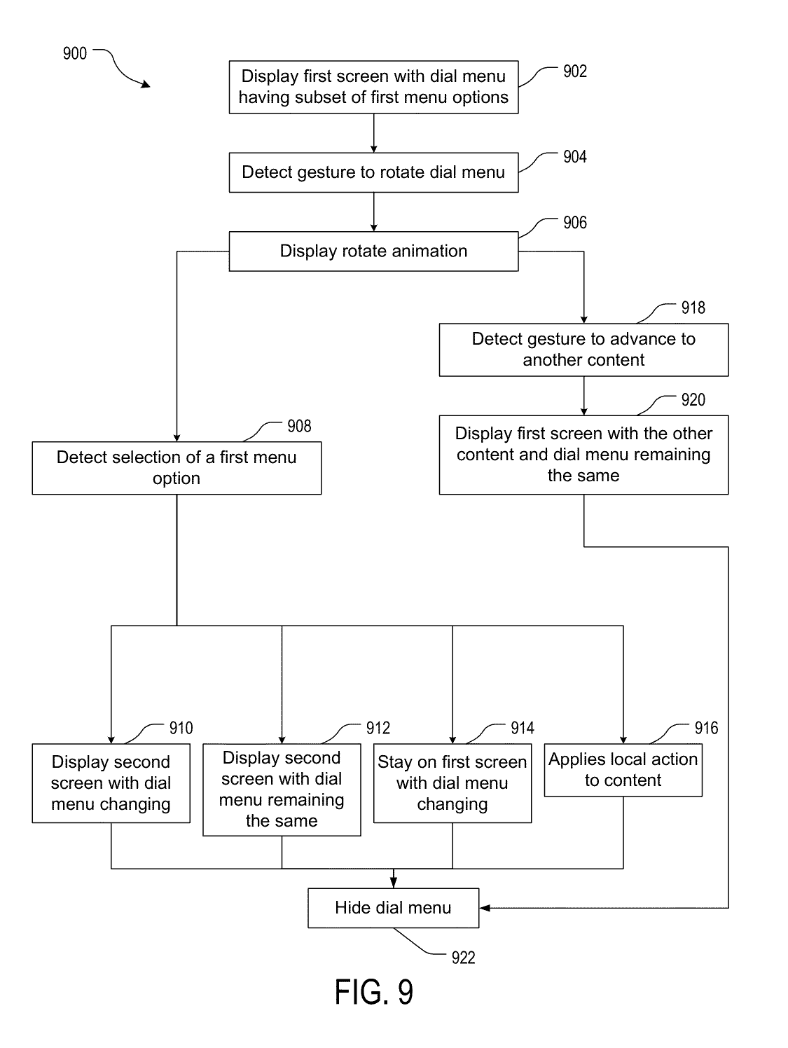

FIG. 9 is a flowchart of a method 900 to implement the dial menu in one or more examples of the present disclosure. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 900 may begin in block 902.

In block 902, processor 802 (FIG. 8) displays a first screen of an application. The first screen includes content and a dial menu (e.g., dial menu 102 in FIGS. 1 to 7) for selecting first menu options. The dial menu includes a subset of the first menu options when they cannot all fit on the dial menu. Block 902 may be followed by block 904.

In block 904, processor 802 detects a gesture to rotate the dial menu. Block 904 may be followed by block 906.

In block 906, processor 802 displays one of the possible animations of the dial menu depending on how far the dial menu is rotated. When the dial menu is not fully retracted or extended, one or more of the first menu options may be rotated off the screen and one or more of the first menu option may be rotated into the first screen. When processor 802 detects that all the first menu options are rotated in a first direction off the first screen to fully retract the dial menu, it displays only a tab representing the head of the dial menu. When processor 802 detects a gesture to pull the tab, it rotates one or more of the first menu options back into the first screen. When processor 802 detects the last of the first menu options is rotated in a second direction past a set point on the first screen to fully extend the dial menu, it displays the dial menu springing back to show one or more of the first menu options. Block 906 may be followed by block 908 or 918 depending on user action.

In block 908, processor 802 detects a selection of a first menu option. Block 908 may be followed by block 910, 912, or 914 depending on the first menu option selected.

In block 910, processor 802 displays a second screen of the application. The second screen including the dial menu, which has been updated for selecting second menu options different from the first menu options. The dial menu includes all of the second menu options or a subset of the second menu options when they cannot all fit on the dial menu. Block 910 may be followed by block 912. Block 910 may be followed by block 922.

In block 912, processor 802 displays a second screen of the application with the dial menu remaining unchanged and having the same first menu options as the first screen. Block 912 may be followed by block 922.

In block 914, processor 802 remains on the first screen but updates the dial menu for selecting third menu options. The dial menu includes all of the third menu options or a subset of the third menu options when they cannot all fit on the dial menu. Block 914 may be followed by block 922.

In block 916, processor 802 locally applies an action to the content in the first screen. Block 916 may be followed by block 922.

In block 918, processor 802 detects a gesture to advance to another content. Block 918 may be followed by block 920.

In block 920, processor 802 displays a third screen with the other content and the dial menu. The dial menu remains unchanged and has the same first menu options as the first screen. Block 920 may be followed by block 922.

In block 922, processor 802 hides the dial menu. As described above, the user may retract the dial menu by rotating it in one direction (e.g., clockwise) until all the menu options are rotated off the screen. In response, processor 802 displays only a tab representing the head of the dial menu.

Various other adaptations and combinations of features of the embodiments disclosed are within the scope of the invention. Numerous embodiments are encompassed by the following claims.

1. A method for providing an interface to an application, comprising:
displaying a first screen of the application, the first screen includes a dial menu for selecting first menu options, the dial menu being shown as an arch about a portion of the first screen, the dial menu being divided into sections, the sections holding a subset of the first menu options;
detecting, using a processor, a gesture to rotate the dial menu;
in response to detecting a gesture to rotate the dial menu, displaying an animated rotation of the dial menu wherein at least one first menu option is rotated off the first screen and, when the number of the first menu options exceed the number of the sections, at least another first menu option is rotated into the first screen;
detecting a selection of a first menu option; and
in response to detecting a selection of a first menu option, displaying a second screen of the application, the second screen including the dial menu for selecting second menu options different from the first menu options, the sections holding at least a subset of the second menu options.

2. The method of claim 1, further comprising:
detecting all the first menu options being rotated in a first direction off the first screen; and
in response to detecting all the first menu options being rotated off the first screen in a first direction, displaying the dial menu in a retracted state with only a tab representing a head of the dial menu.

3. The method of claim 2, further comprising:
detecting a gesture on the tab; and
in response to detecting a gesture on the tab, displaying another animated rotation of the dial menu to bring back the dial menu with one or more of the first menu options.

4. The method of claim 2, further comprising:
detecting the last of the first menu options being rotated in a second direction past a point on the first screen; and
in response to detecting the last of the first menu options being rotated in a second direction past a point on the first screen, displaying an animated spring back of the dial menu wherein additional first menu options are brought back into view on the first screen.

5. The method of claim 1, wherein the dial menu is about an edge of the first screen, and the first screen further comprises third menu options in an area between the dial menu and the edge of the first screen.

6. The method of claim 1, further comprising:
detecting a selection of another first menu option; and
in response to detecting a selection of another first menu option, updating the dial menu for selecting third menu options by replacing the subset of the first menu options in the sections with at least a subset of the third menu options.

7. The method of claim 1, wherein the first screen includes a content, the method further comprises:
detecting a gesture to advance to another content; and
in response to detecting a gesture to advance to another content, displaying the first screen with the other content and the dial menu with the subset of the first menu options.

8. The method of claim 1, wherein the first screen includes a content, the method further comprises:
detecting a selection of another first menu option; and
in response to the selection of another first menu option, applying an action locally to the content.

9. A method for providing an interface to an application, comprising:
displaying a screen of the application, the screen includes a dial menu for selecting first menu options, the dial menu being divided into sections, the sections holding a subset of the first menu options, the subset of the first menu options being arranged in a non-linear path about an edge of the screen, the screen further includes second menu options in an area between the dial menu and the edge of the screen;
detecting, using a processor, a gesture to rotate the dial menu; and
in response to detecting a gesture to rotate the dial menu, displaying an animated rotation of the dial menu wherein at least one first menu option is rotated off the first screen and, when the number of the first menu options exceed the number of the sections, at least another first menu option is rotated into the first screen.

10. The method of claim 9, wherein the dial menu has an arch or a U shape.

11. The method of claim 9, further comprising:
detecting a selection of a first menu option; and
in response to detecting a selection of a first menu option, displaying another screen of the application, the other screen including the dial menu for selecting third menu options different from the first menu options, the sections holding at least a subset of the third menu options.

12. The method of claim 9, further comprising:
detecting all the first menu options being rotated in a first direction off the screen; and
in response to detecting all the first menu options being rotated off the screen in a first direction, displaying the dial menu in a retracted state with only a tab representing a head of the dial menu.

13. The method of claim 12, further comprising:
detecting a gesture on the tab; and
in response to detecting a gesture on the tab, displaying another animated rotation of the dial menu to bring back the dial menu with one or more of the first menu options.

14. The method of claim 12, further comprising:
detecting the last of the first menu options being rotated in a second direction past a point on the screen; and
in response to detecting the last of the first menu options being rotated in a second direction past a point on the screen, displaying an animated spring back of the dial menu wherein additional first menu options are brought back into view on the screen.

15. The method of claim 9, further comprising:
detecting a selection of a first menu option; and
in response to detecting a selection of a first menu option, updating the dial menu for selecting third menu options by replacing the subset of the first menu options in the sections with at least a subset of the third menu options.

16. The method of claim 9, wherein the screen includes a content, the method further comprises:
detecting a gesture to advance to another content; and
in response to detecting a gesture to advance to another content, displaying the first screen with the other content and the dial menu with the subset of the first menu options.

17. The method of claim 9, wherein the screen includes a content, the method further comprises:
detecting a selection of a first menu option; and
in response to the selection of a first menu option, applying an action locally to the content.

18. A method for providing an interface to an application, comprising:
displaying a screen of the application, the screen including a dial menu for selecting menu options, the dial menu being in a retracted state with only a tab representing a head of the dial menu showing;
detecting, using a processor, a gesture on the tab; and
in response to detecting a gesture on the tab, displaying an animated rotation of the dial menu wherein at least a subset of the menu options is rotated onto the screen, the menu options being arranged in a nonlinear fashion.

19. The method of claim 18, further comprising:
in response to detecting a gesture to rotate the dial menu, displaying an animated rotation of the dial menu wherein at least one menu option is rotated off the screen and, when the number of the menu options exceed the number of the sections, at least another menu option is rotated into the screen.

20. The method of claim 19, further comprising:
detecting the last of the menu options being rotated in a second direction past a point on the screen; and
in response to detecting the last of the menu options being rotated in a second direction past a point on the screen, displaying an animated spring back of the dial menu wherein additional menu options are brought back into view on screen.
